(19) United States
(12) Patent Application Publication
(10) Pub. No.: US 2014/0301424 A1
(43) Pub. Date: Oct. 9, 2014

(54) METHOD AND APPARATUS FOR MEASURING THERMAL CONDUCTIVITY

(71) Applicant: SGL CARBON SE, WIESBADEN (DE)

(72) Inventors: WOJCIECH ADAMCZYK, MIKOLOW (PL); RYSZARD BIALECKI, GLIWICE (PL); TADEUSZ KRUCZEK, GLIWICE (PL)

(21) Appl. No.: 14/311,556

(22) Filed: Jun. 23, 2014

Related U.S. Application Data
(63) Continuation of application No. PCT/EP2012/076250, filed on Dec. 19, 2012.

(30) Foreign Application Priority Data
Dec. 23, 2011 (EP) 11195498.8

(51) Int. Cl. G01N 25/18

(52) U.S. Cl. CPC G01N 25/18
USPC 374/44

(57) ABSTRACT

A method for measuring thermal conductivity of a material contains the now described steps. A heat pulse is applied to a front side of the material. The resulting time-dependent two-dimensional temperature field of the front side of the material is detected using an infrared detector. An isotherm is identified in the temperature field. First and second thermal conductivities of the material in first and second directions of the material are calculated on the basis of the shape of the isotherm and on the basis of first and second temperatures detected at one point of the front side of the material at two points in time.

### CROSS-REFERENCE TO RELATED APPLICATION

This is a continuation application, under 35 U.S.C. §120, of copending international application No. PCT/EP2012/076250, filed Dec. 19, 2012, which designated the United States; this application also claims the priority, under 35 U.S.C. §119, of European patent application EP 11 195 498.8, filed Dec. 23, 2011; the prior applications are herewith incorporated by reference in their entireties.

### BACKGROUND OF THE INVENTION

### Field of the Invention

The present invention relates to a method for measuring thermal conductivity of a material.

The statements in this section merely provide background information related to the present invention and may not constitute prior art.

Thermal conductivity is the capability of a material to conduct heat. Measurement of thermal conductivity plays a major role in the analysis of materials in many different industries such as the automotive industry, chemical industry, electronics industry and construction. In heat accumulators, for example, materials with high thermal conductivity may be used. A heat shield, however, is required to have a low thermal conductivity. State of the art techniques for measuring thermal conductivity are described in the “Handbook of Materials Measurement Methods” by H. Czichos, T. Saito, and L. Smith (Eds.), 2006, Springer, pp. 399-408. There are three fundamental methods available to measure thermal conductivity.

A first method is referred to as a steady-state method. Heat is constantly applied to a sample in order to reach thermal equilibrium, i.e. until the temperature does not depend on time anymore at each point of the sample. Consequently, steady-state techniques are very time-consuming. Moreover, it is difficult to maintain the same boundary conditions over time when carrying out such methods. Some techniques additionally require a reference material. Further, contact heating may produce additional problems due to thermal contact resistance at the interface between the heat source and the sample.

According to a second transient method, a temperature change over time at one point of the sample is analyzed. This method has the advantage of being a lot faster than the steady-state technique. The laser flash method is a widely-used transient method which is based on heating of a sample by a short laser pulse on the front side of a sample and analyzing the corresponding temperature rise at the back side of the sample. This method, however, is destructive since the preparation of a specific sample is required. Moreover, this method is based on a 1-dimensional model allowing the determination of thermal conductivity in one direction of the sample only. The determination of the thermal conductivity of an anisotropic media, i.e. in two directions, requires the preparation of two separate samples and two separate measurements.

A third method involves using an oscillating heat source that is either located on a surface of a sample or radiates modulated heat to that surface. Based on a phase shift between the modulated heat signal provided by the heat source and a response signal measured by a temperature sensor, and based on the amplitudes of these two signals, the diffusivity of the sample can be calculated. However, this method is very complex.

None of the known methods is fully non-destructive. All of these methods require the preparation of a sample of a specific shape, such as a small cylinder or a thin foil. In addition, most of them require long measurement times and/or can be carried out in a lab environment only rather than in an industrial environment. Generally, the methods are optimized and restricted, respectively, for a specific class of materials and/or temperature range.

### SUMMARY OF THE INVENTION

One object of the invention is to overcome the disadvantages associated with the known methods for measuring thermal conductivity.

Accordingly, the present invention provides a method for measuring thermal conductivity of a material. The method contains the now described steps. A heat pulse is applied to a front side of the material. The resulting time-dependent two-dimensional temperature field of the front side of the material is detected using an infrared detector. An isotherm is identified in the detected temperature field. First and second thermal conductivities of the material in first and second directions of the material are calculated on the basis of the shape of the isotherm and on the basis of first and second temperatures detected at one point of the front side of the material at two points in time.

The method according to the invention permits a non-contact and non-destructive measurement of large dimensioned materials. There is no need for preparation and thus for permanently altering the material to be analyzed. In addition, the method according to the invention allows to simultaneously determining two components of the conductivity tensor of a material. In particular, the first and second conductivities correspond to two components or axes of the heat conductivity tensor which are parallel to the front side of the medium. The material may be an anisotropic material, in particular an orthotropic material, or an isotropic material.

The thermal conductivity of the material may be between 0.1 W/m·K and 500 W/m·K, preferably between 1 W/m·K and 200 W/m·K, more preferably between 3 W/m·K and 50 W/m·K.

The measurement time may be reduced to a few seconds or less. In addition, the amount of heat absorbed by the material does not have to be known. Further, the thermal conductivities can be determined with a high accuracy and low effort at low cost.

In accordance with an aspect of the invention, in particular to assess the shape of the isotherm, a mathematical function, in particular an ellipse, is fitted to the isotherm. A circle may be regarded a special case of an ellipse. The method of least squares may be used to carry out the curve fitting.

In accordance with another aspect of the invention, the first and second thermal conductivities are calculated on the basis of at least one geometric parameter of the mathematical function, in particular on the basis of the lengths of the major and minor axes of the ellipse or of the radius of a circle.

In accordance with yet another aspect of the invention, the ratio of the first thermal conductivity to the second thermal conductivity is calculated on the basis of the ratio of the length of the major axis or major semi-axis of the ellipse to the length of the minor axis or minor semi-axis of the ellipse.

In accordance with still another aspect of the invention, the thermal conductivity of the material in the first direction is calculated on the basis of equation (2) mentioned below.

In accordance with still yet another aspect of the invention, the thermal conductivity of the material in the second direction is calculated on the basis of the ratio of the first temperature to the second temperature.

In accordance with another aspect of the invention, the thermal conductivity of the material in the second direction is calculated on the basis of equation (3) mentioned below.

In accordance with another aspect of the invention, first and second thermal conductivities are calculated for each of a plurality of points of the front side of the material. Thus, the reliability of the measurement may be enhanced. The according plurality of first and second temperatures may be detected at the same two points in time.

In accordance with another aspect of the invention, a plurality of heat pulses is applied to the front side of the material at different positions, wherein first and second thermal conductivities are calculated for each heat pulse. The method of the present invention may then be used for non-homogeneous materials, in particular for grained materials. Measurements yielding ellipses deformed beyond given limits may then be disregarded.

In accordance with another aspect of the invention, the central axis of the field of view of the infrared detector is aligned with the propagation direction of the heat pulse applied to the front side of the material. Additionally or alternatively, the central axis of the field of view of the infrared detector and/or the propagation direction of the heat pulse applied to the front side of the material is arranged at least substantially perpendicular to the front side of the material. Geometric distortions of the detected temperature field and/or of the pulse spot projected onto the front side of the material resulting from tilted viewing angles and/or tilted angles of incidence can be avoided. Thus, the complexity of the calculations involved in the present invention can be minimized.

In accordance with another aspect of the invention, the infrared detector and a heat pulse generator, in particular a laser, for applying a heat pulse to the front side of the material are arranged or located on the same side of the material. Thus, the preparation of thin samples as required by the laser flash method to allow a detection of a rise of temperature on the back side of the sample is not necessary.

The invention further provides an apparatus for measuring thermal conductivity of a material, in particular for carrying out the method for measuring thermal conductivity of a material according to the invention. The apparatus contains a heat pulse generator, in particular a laser, for applying a heat pulse, in particular a light pulse, to a front side of the material. The apparatus further contains an infrared detector configured for detecting the resulting time-dependent two-dimensional temperature field of the front side of the material. In addition, the apparatus contains an evaluation unit configured for identifying an isotherm in the detected temperature field and for calculating first and second thermal conductivities of the material in first and second directions of the material on the basis of the shape of the isotherm and on the basis of first and second temperatures detected or sampled at one point of the front side of the material at two points in time.

Preferably, the heat pulse generator, and/or a head coupled to the heat pulse generator and directing the heat pulse to the front side of the material, is movable between first and second locations, wherein, in the first location, the heat pulse generator and/or the head lies on the central axis of the field of view of the infrared detector, and wherein, in the second location, the heat pulse generator and/or the head is located away from the central axis of the field of view of the infrared detector, in particular is located out of the field of view of the infrared detector.

An assembly including the head and the heat pulse generator and/or the head as well as the infrared detector may be movable in a plane perpendicular to the propagation direction of the heat pulse applied to the front side of the material, i.e. movable parallel to the front side of the material. This allows for evaluation of the first and second thermal conductivities for different positions at which the laser pulse impinges on the front side of the material as mentioned above. In particular, an average value for each of the first and second thermal conductivities may be calculated.

In addition, the invention contains preferred embodiments of the apparatus according to the invention analogous to the aspects of the method according to the invention.

Further areas of applicability will become apparent from the description provided herein. It should be understood that the description and specific examples are intended for purpose of illustration only and are not intended to limit the scope of the present invention.

Other features which are considered as characteristic for the invention are set forth in the appended claims.

Although the invention is illustrated and described herein as embodied in a method and device for measuring thermal conductivity, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

The drawings described herein are included for illustration purposes only and are not intended to limit the scope of the present invention in any way.

### BRIEF DESCRIPTION OF THE SEVERAL VIEWS OF THE DRAWING

FIG. 1 is an illustration of an isotherm of a two-dimensional temperature field;

FIG. 2 is a block diagram of an apparatus for measuring thermal conductivities of a material according to the invention; and

FIG. 3 is a flowchart of a method for measuring thermal conductivities according to the invention.

### DETAILED DESCRIPTION OF THE INVENTION

The following description is merely exemplary in nature and is not intended to limit the present invention, application, or uses. It should be understood that throughout the drawings, corresponding reference numerals indicate like or corresponding parts and features.

To measure the thermal conductivities of a medium or material, either isotropic or anisotropic, a heat pulse is applied to a planar front side of the material using a heat source, in particular a laser, producing a temporary preferably point-like light spot or hot spot on the material. The front side is that side of the material to which the heat pulse is applied, in particular that side which faces the heat source. In general, each side of a material qualifies as the front side. It was established by the inventors of the present invention that—assuming a semi-infinite medium or material having a thermally insulated surface heated temporary at a point-like position and assuming a material, in particular an orthotropic material, having two axes of the conductivity tensor parallel to the surface of the material—the resulting two-dimensional temperature field of the front side of the material can be described by the following equation

$$T ( x , y , z = 0 , τ ) - {T}_{ini} ( x , y , z = 0 , τ = 0 ) = \frac{q \sqrt{c {ϱλ}_{y}}}{4 {π}^{3 / 2} \sqrt{{k}_{y}^{3}} \sqrt{{τ}^{3}}} exp [ - \frac{c ϱ}{4 {λ}_{y} τ} ( {X}^{2} {k}_{y} + {y}^{2} ) ] , \qquad ( 1 )$$

wherein T is the temperature at time τ at point (x, y) on the plane front side surface (z=0) of the material in Cartesian coordinates, Tᵢₙᵢ is the initial temperature at point (x, y), z is the Cartesian coordinate perpendicular to the surface, q is the energy of the applied pulse, [symbol] is the apparent density of the material, c is the specific heat of the material, k_{y}=λ_{y}/λₓ, and λₓ and λ_{y} are the thermal conductivities of the material in first and second in-plane directions x and y.

In the model according to equation (1), isotherms of the temperature field, i.e. lines that connect coordinate points that have the same temperature, are represented by ellipses having major and minor semi-axes a and b, wherein the ratio of the lengths of a and b equals the square root of the ratio of the thermal conductivities λₓ and λ_{y}, in first and second directions x and y as described by the following equation

$${k}_{y} = \frac{{λ}_{y}}{{λ}_{x}} = {( \frac{b}{a} )}^{2} . \qquad ( 2 )$$

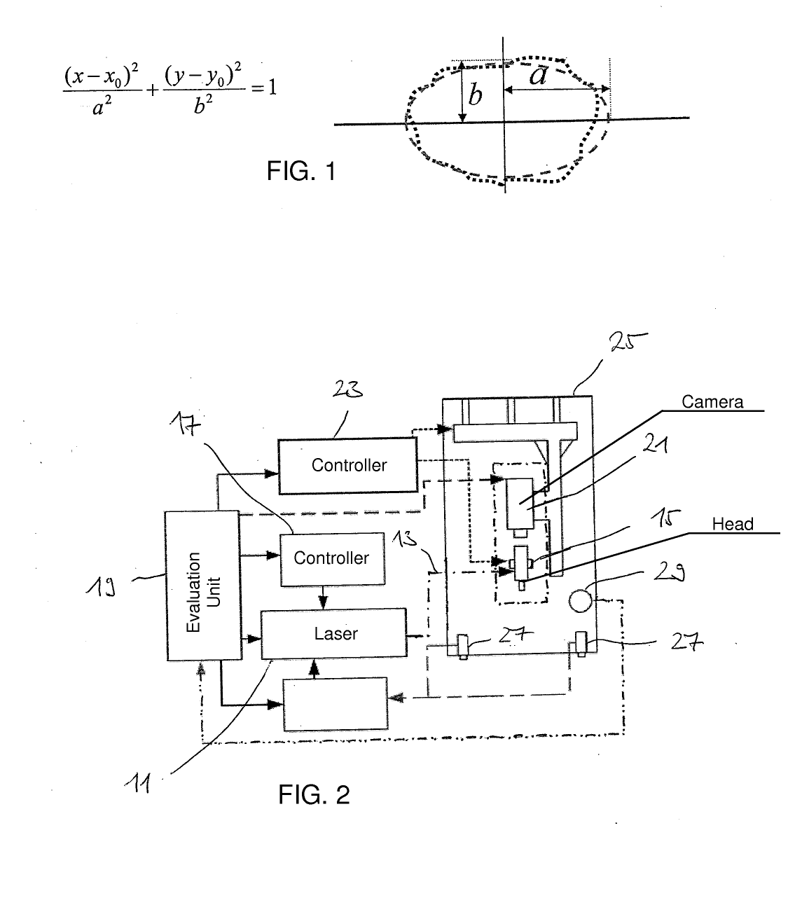

In practice, the isotherms of the measured temperature field deviate from an ideal elliptical shape. Thus, the lengths of the semi-axes a and b can be established, for example, by curve-fitting the measured data of an isotherm using the method of least squares. This is illustrated in FIG. 1.

As is evident from equation (1), the temperature at each point of the front side surface of the material depends on the absorbed amount of energy q. As this quantity is difficult to assess, the ratio θ of two temperatures at the same coordinate point at two points in time τ₁ and τ₂ is formed resulting in the following equation

$$\begin{matrix}θ ( x , y , {τ}_{1} , {τ}_{2} , {λ}_{y} , {k}_{y} ) = \frac{T ( x , y , z = 0 , {τ}_{1} ) - {T}_{ini} ( x , y , z = 0 , τ = 0 )}{T ( x , y , z = 0 , {τ}_{2} ) - {T}_{ini} ( x , y , z = 0 , τ = 0 )} \\ = \frac{\sqrt{{τ}_{2}^{3}}}{\sqrt{{τ}_{1}^{3}}} exp [ - \frac{c ϱ}{4 {λ}_{y}} ( {x}^{2} {k}_{y} + {y}^{2} ) ( \frac{1}{{τ}_{1}} - \frac{1}{{τ}_{2}} ) ] .\end{matrix} \qquad ( 3 )$$

From there, knowing the apparent density [symbol] and the specific heat c of the material from other measurements, and knowing k_{y} from equation (2), the thermal conductivity λ_{y} in the second direction y can be calculated.

Knowing the thermal conductivity λ_{y} in the second direction y, the thermal conductivity λₓ in the first direction x can be calculated on the basis of equation (2).

For an isotropic material, i.e. a material having identical thermal conductivity values in all directions, isotherms of the temperature field are represented by circles, i.e. a=b resulting in k_{y}=1. Thus, the method according to the invention is suited for measuring the thermal conductivity of an anisotropic material, in particular of an orthotropic material, but is applicable to an isotropic material as well.

The point used for calculating the first and second thermal conductivities may or may not lie on the isotherm and/or on the mathematical function fitted to the isotherm. Further, more than one isotherm may be identified and thus more than one corresponding mathematical function may be fitted to the plurality of identified isotherms. This allows to increase the accuracy and/or reliability of the determination of the geometric parameters of the mathematical function on which basis the first and second thermal conductivities are calculated.

Preferably, the determination of the thermal conductivities λₓ and λ_{y} is based on a plurality of points of the front side of the material, wherein thermal conductivities λₓ and λ_{y} are calculated as outlined above for each point. The plurality of first and second temperatures are sampled at the same two consecutive points in time τ₁ and τ₂. The resulting plurality of thermal conductivities λₓ and λ_{y} can then be curve-fitted by the method of least squares for instance resulting in enhanced accuracy of the measurement. This approach is due to the fact that the determination of the thermal conductivities λₓ and λ_{y} is an inverse problem and, as such, is ill-conditioned, i.e. small errors in the input data produce large errors in the output. The above-mentioned optimization is carried out to mitigate this effect. The least squares problem can be described by the following equation

Σᵢ^{N}[θ(xᵢ, yᵢ, τ₁, τ₂, λ_{y}, λ_{y})−θ_{measured}(xᵢ, yᵢ, τ₁, τ₂)]²→min, (4)

wherein N is the total number of analyzed coordinate points, xᵢ and yᵢ are the Cartesian coordinates of point i, and θ_{measured} is the ratio of the temperatures measured at coordinate point i at time instants τ₁ and τ².

Referring now to FIG. 2, an apparatus for carrying out the above-outlined measurement method is illustrated. The apparatus contains a laser 11 configured to emit and/or transmit a laser pulse and an optical fiber 13 coupled to the laser 11 to transmit the light pulse from the laser 11 to an optical head 15. The light pulse is focused and directed to a point-like location on a planar front face of a non-illustrated material by the head 15. The laser 11 is controlled by a laser controller 17. The apparatus further contains an infrared camera 21 to detect the temperature field of the front face of the material after application of the energy pulse to the material.

The head 15 is movable in one dimension by a linear motor. The assembly containing the head 15 and the infrared camera 21 is in total movable in two-dimensions parallel to the front face of the material by two step motors. The linear motor and the step motors are coupled to a respective controller 23. The laser controller 17, the infrared camera 21, and the linear and step motors controller 23 are coupled to a processor 19 or evaluation unit. The processor 19 is equipped with software for controlling the coupled parts and for evaluating the temperature field detected by the infrared camera 21 to determine the thermal conductivities λₓ and λ_{y}.

The duration of the laser pulse may range between 0.01 s and 10 s for example, in particular between 0.05 s and 1s. The energy of the laser pulse may range between 10 W and 500 W for example, in particular between 50 W and 300 W. The wavelength of the laser pulse may be in the range of 600 nm to 1000 nm. The diameter of the pulse spot projected onto the medium should be as point-like as possible and may in practice have a diameter of 1 mm for example. τ₁ may be in the range of 0.1 s to 1 s and τ₂ may be in the range of 0.4 s to 5 s after the application of the heat pulse for example. The optimum settings for carrying out the measurement may depend on the material to be analyzed and thus may be different from the above-mentioned values.

The head 15 and the infrared camera 21 are mounted in a closed cage 25 that may be lowered down to contact the front face of the material. Limit switches 27 are arranged on the lower side of the cage 25 to provide a contact signal which may be used to switch the laser 11 on/off. The limit switches 27 are used for safety reasons in order to prevent the laser 11 from uncontrolled emission. Further, an optical camera 29 is provided to monitor and/or to check the conditions and/or the correct operating of the apparatus within the cage 25.

In operation, the intensity of radiation resulting from the heating-up of the surface of the material by the laser pulse is detected by the image sensor or pixels of the infrared camera. The above-mentioned software then transforms the intensities into temperatures of the surface of the material. Then, points corresponding to an isotherm, which points may by interpolated from the detected temperatures of neighboring pixels, are selected and an ellipse is curve-fitted by a least squares fit to the selected isotherm. In a next step, the ratio of the lengths of the major and minor axes of the ellipse is used to determine the ratio of the corresponding two main axes of the heat conductivity tensor of the material. In a further step, ratios of two temperatures detected at two selected points in time are calculated for a set of coordinate points. The ratios are least square-fitted to the corresponding measured ratios to determine one of the heat conductivities. The second conductivity is then evaluated from equation (2).

The central axis of the field of view of the infrared camera 21 is arranged perpendicular to the irradiated surface of the material in order to avoid geometric distortion of the detected temperature field. In addition, the head 15 is oriented such that the propagation direction of the laser pulse is also perpendicular to this surface to avoid geometric distortion of the pulse spot projected onto this surface.

In a first position, the head 15 and the infrared camera 21 are arranged in a coaxial manner, i.e. the central axis of the field of view of the infrared camera 21 and the propagation direction of the light pulse applied by the head 15 are aligned. Since the infrared camera 21 and the head 15 lie at the same side of the material, the head 15 is then located between the material and the infrared camera 21. In the first position of the head 15, the laser pulse is applied to the material.

In a second position, the head 15 is moved out of the infrared camera's field of view allowing an unhindered detection of the temperature field of the irradiated surface of the material. The movement of the head 15 is accomplished by the above-mentioned linear motor.

The above-mentioned two step motors are used to move the whole assembly including the head 15 and the infrared camera 21 off to another location. Hereby it is made possible to repeat the above-outlined measurement at various nearby locations. This allows for using the above described measurement technique for materials of inhomogeneous structure, in particular for a carbon material. In particular, the material may have a grainy structure. However, the above model assumes constant material properties. The presence of large grains in the vicinity of the impingement point of the laser pulse may deform the elliptical shape of the isotherms. For a measurement based on a laser pulse which does not impinge on a grain centrally, the resulting isotherms may not resemble ellipses. As a consequence, such a measurement may be rejected. Due to the plurality of measurements carried out at different positions, in particular at different positions close to one other, enough measurements remain on which the determination of thermal conductivities may be based. In particular, the plurality of measurements may be used to check and/or verify the consistency of the obtained results.

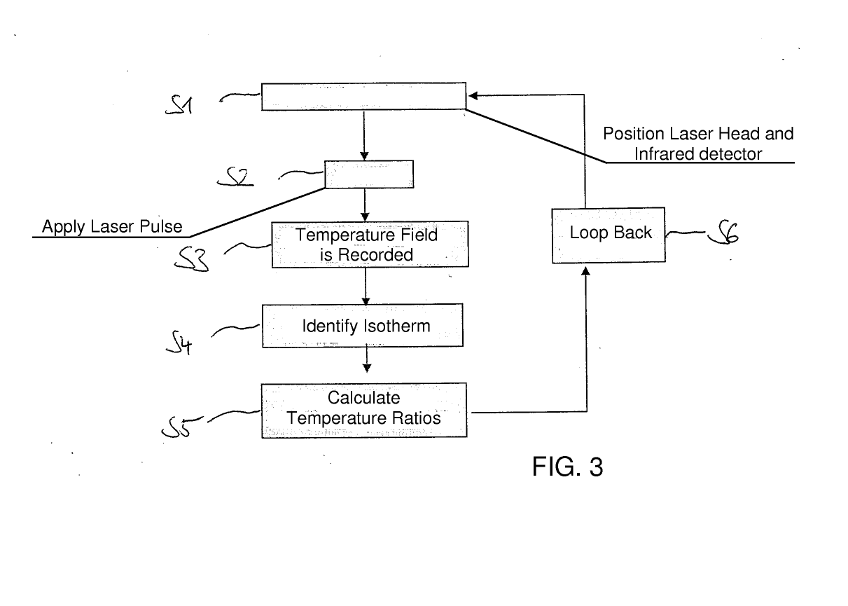

The method steps for carrying out the determination of thermal conductivities are summarized in FIG. 3. In step S1, the assembly of laser head and infrared detector, in particular an infrared camera, are positioned at a location j. In step S2, a laser pulse is applied to a flat front side or face of the medium. In step S3, the resulting temperature field of the front face is recorded. In step S4, an isotherm of the temperature field is identified and/or selected and an ellipse is curve-fitted to the isotherm. In step S5, model temperature ratios are calculated for a set of points of the front face of the material and curve-fitted. Then the process loops back to step S1 (as shown by step S6), wherein the laser head and infrared detector are positioned at a next location different from the foregoing locations to repeat the method steps S1 to S5.

Tables 1 and 2 illustrate experimental results obtained on a piece of carbon material using the method and apparatus according to the invention.

The in-plane thermal conductivities λₓ and λ_{y} of a first side of the carbon material were measured for five different positions of the laser pulse on the surface of the carbon material, and these measurements are reproduced in Table 1. In addition, the mean values of the thermal conductivities λₓ and λ_{y} as well as corresponding results of a reference measurement according to another measurement technique are given.

TABLE 1
Measurement of thermal conductivities λₓ and
λ_{y} on a first side of a carbon material:

| Measurement No. | λ_{y} in W/mK | λₓ in W/mK |
|---|---|---|
| 1 | 14.90 | 13.81 |
| 2 | 15.20 | 13.77 |
| 3 | 14.90 | 13.45 |
| 4 | 14.45 | 13.18 |
| 5 | 14.90 | 13.75 |
| Mean | 14.9 | 13.6 |
| Reference | 14.5 | 13.5 |

The measurement corresponding to Table 2 was carried out on the same piece of carbon material as the measurement corresponding to Table 1, wherein, however, the piece of material was rotated by 90 degrees such that the laser pulse was applied to a second surface of the carbon material to measure the in-plane thermal conductivities λ_{z} and λ_{y}.

TABLE 2
Measurement of thermal conductivities λ_{z} and λₓ
on a second side of the carbon material in Table 1

| Measurement No. | λ_{z} in W/mK | λₓ in W/mK |
|---|---|---|
| 1 | 14.48 | 13.57 |
| 2 | 16.48 | 15.04 |
| 3 | 15.30 | 14.10 |
| mean | 15.4 | 14.5 |
| reference | 15.6 | 13.5 |

λ_{y} and λₓ denote thermal conductivities with grain, and λₓ denotes a thermal conductivity against grain for the analyzed carbon material. According to document ASTM C 709-03a “Standard Terminology Relating to Manufactured Carbon and Graphite”, the term “with grain” is used to describe the direction in a body with preferred orientation due to forming stresses that has the maximum a-axis alignment as measured in an X-ray diffraction test, and the term “against grain” is used to describe direction in a body with preferred orientation due to forming stresses that has the maximum c-axis alignment as measured in an X-ray diffraction test.

The present invention is based on the idea of heating a flat surface of a material to be examined with a laser pulse and to analyze the temperature field at the same surface of the material using an infrared camera. The temperature field monitored by the camera is then processed in a processor, evaluation unit and/or computer. For a material, in particular an orthotropic material, having two main axes of the conductivity tensor parallel to the illuminated surface, the shapes of the isotherms of the temperature field are used to assess the ratio of the in-plane heat conductivities. The same recorded temperature field is then used to evaluate the heat diffusivity of the material. This is accomplished by establishing, for each of a selected number of points on the surface of the material and/or for each of a selected number of camera pixels, a ratio of temperatures at two properly selected points in time. Heat capacity and apparent density of the material are determined in a separate experiment. Knowing these material properties, the heat conductivities for in-plane entries of the conductivity tensor are calculated.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

### REFERENCE NUMERAL LIST

11 laser
13 optical fiber
15 optical head
17 laser controller
19 processor
21 infrared camera
23 linear and step motors controller
25 cage
27 limit switch
29 optical camera

1. A method for measuring thermal conductivity of a material, the method comprises the steps of:
applying a heat pulse to a front side of the material;
detecting a resulting time-dependent two-dimensional temperature field of the front side of the material using an infrared detector;
identifying an isotherm in the temperature field detected; and
calculating first and second thermal conductivities of the material in first and second directions of the material on a basis of a shape of the isotherm and on a basis of first and second temperatures detected at one point of the front side of the material at two points in time.

2. The method according to claim 1, which further comprises fitting a mathematical function to the isotherm.

3. The method according to claim 2, which further comprises using a method of least squares to carry out a curve fitting.

4. The method according to claim 2, which further comprises calculating the first and second thermal conductivities on a basis of at least one geometric parameter of a mathematical function.

5. The method according to claim 4, which further comprises calculating a ratio of the first thermal conductivity to the second thermal conductivity on a basis of a ratio of a length of major axis of an ellipse to a length of minor axis of the ellipse.

6. The method according to claim 2, which further comprises calculating a thermal conductivity of the material in therst direction on a basis of the following equation:
$${k}_{y} = \frac{{λ}_{y}}{{λ}_{x}} = {( \frac{b}{a} )}^{2} ,$$
wherein λₓ and λ_{y} are the thermal conductivities in the first and second directions of the material, a and b are major and minor semi-axes of an ellipse or a=b is a radius of a circle, and k_{y}=λ_{y}/λₓ.

7. The method according to claim 1, which further comprises calculating the thermal conductivity of the material in the second direction on a basis of a ratio of the first temperature to the second temperature.

8. The method according to claim 1, which further comprises calculating the thermal conductivity of the material in the second direction on a basis of the following equation:
$$\begin{matrix}θ ( x , y , {τ}_{1} , {τ}_{2} , {λ}_{y} , {k}_{y} ) = \frac{T ( x , y , z = 0 , {τ}_{1} ) - {T}_{ini} ( x , y , z = 0 , τ = 0 )}{T ( x , y , z = 0 , {τ}_{2} ) - {T}_{ini} ( x , y , z = 0 , τ = 0 )} \\ = \frac{\sqrt{{τ}_{2}^{3}}}{\sqrt{{τ}_{1}^{3}}} exp [ - \frac{c ϱ}{4 {λ}_{y}} ( {x}^{2} {k}_{y} + {y}^{2} ) ( \frac{1}{{τ}_{1}} - \frac{1}{{τ}_{2}} ) ] ,\end{matrix}$$
wherein T(x,y,z=0,τ₁) is a temperature at coordinate point (x,y,z=0) at time τ₁, T(x,y,z=0,τ₂) is a temperature at coordinate point (x,y,z=0) at time τ₂, Tᵢₙᵢ is an initial temperature at point (x,y,z=0), [symbol] is an apparent density of the material, c is a specific heat of the material, λ_{y} is the thermal conductivity in the second direction of the material, and k_{y}=λ_{y}/λₓ.

9. The method according to claim 1, which further comprise calculating the first and second thermal conductivities in such a manner for each of a plurality of points of the front side of the material.

10. The method according to claim 9, which further comprises detecting the according plurality of the first and second temperatures at a same two points in time.

11. The method according to claim 1, which further comprises applying a plurality of heat pulses to the front side of the material at different positions, wherein the first and second thermal conductivities are calculated as afore-mentioned for each of the heat pulses.

12. The method according to claim 1, which further comprises aligning a central axis of a field of view of the infrared detector with a propagation direction of the heat pulse applied to the front side of the material.

13. The method according to claim 1, wherein a central axis of a field of view of the infrared detector and/or a propagation direction of the heat pulse applied to the front side of the material is disposed perpendicular to the front side of the material.

14. The method according to claim 1, which further comprises disposing the infrared detector and a heat pulse generator for applying the heat pulse to the front side of the material, on a same side of the material.

15. The method according to claim 1, which further comprises fitting an ellipse to the isotherm.

16. The method according to claim 2, which further comprises calculating the first and second thermal conductivities on a basis of lengths of major and minor axes of the ellipse.

17. The method according to claim 1, which further comprises disposing the infrared detector and a laser for applying the heat pulse to the front side of the material, on a same side of the material.

18. An apparatus for measuring thermal conductivity of a material, the apparatus comprising:
a heat pulse generator for applying a heat pulse to a front side of the material;
an infrared detector for detecting a resulting time-dependent two-dimensional temperature field of the front side of the material;
an evaluation unit for identifying an isotherm in the temperature field detected and for calculating first and second thermal conductivities of the material in first and second directions of the material on a basis of a shape of the isotherm and on a basis of first and second temperatures detected at one point of the front side of the material at two points in time.

19. The apparatus according to claim 18, further comprising a head coupled to said heat pulse generator and directing the heat pulse to the front side of the material, said pulse generator and/or said head coupled to said heat pulse generator is movable between first and second locations, wherein, in the first location, said heat pulse generator and/or said head lies on a central axis of a field of view of said infrared detector, and wherein, in the second location, said heat pulse generator and/or said head is disposed away from the central axis of the field of view of said infrared detector.

20. The apparatus according to claim 19, wherein an assembly including said heat pulse generator and/or said head and said infrared detector is movable in a plane perpendicular to a propagation direction of the heat pulse applied to the front side of the material.
